(19) United States
(12) Patent Application Publication
(10) Pub. No.: US 2015/0294399 A1
(43) Pub. Date: Oct. 15, 2015

(54) SYSTEMS AND METHODS FOR EXCHANGING ITEMS

(71) Applicant: Daniel SPAULDING, Lino Lakes, MN (US)

(72) Inventor: Daniel SPAULDING, Lino Lakes, MN (US)

(21) Appl. No.: 14/252,968

(22) Filed: Apr. 15, 2014

(51) Int. Cl. G06Q 30/06

(52) U.S. Cl. CPC G06Q 30/0641

(57) ABSTRACT

Systems and methods for exchanging items are described. The system facilitates transactions between two or more users. A device may be configured to present one or more possible transactions to a user. The possible transactions may include transactions including two or more users. Possible transactions may be presented based on criteria provided by a user. A device may provide graphical user interfaces to a user in order to facilitate the execution of a transaction.

### TECHNICAL FIELD

This disclosure relates to exchanging items, and more particularly to techniques for facilitating multi-user trades.

### BACKGROUND

Online auction and classified services allow users thereof to create a posting describing an item that they would like to sell. Examples of online auction and classifieds services include eBay and Craigslist. Online auction and classified services typically allow users to specific a monetary amount that they would like to receive in exchange for their item. Although some online auction and classifieds services allow users to describe particular items that they would like to receive in exchange for the item listed in a posting, current online auction and classified services are limited in the types of transactions that may be facilitated through a user creating a posting.

### SUMMARY

In general this disclosure describes techniques for exchanging items. In particular, this disclosure describes example techniques for facilitating transactions between multiple users. It should be noted that although the examples described herein relate to bartering, the techniques may be more generally applied to any type of transaction.

According to one example of the disclosure, a method of facilitating item exchanges comprises providing an interface enabling a user to associate information with an item the user owns, providing an interface enabling the user to associate information with an item the user wants to receive, determining whether information associated with the item the user wants to receive matches information associated with an item another user owns, and providing an interface enabling the user to pursue a transaction with another user owning an item associated with information matching the information associated with the item the user wants to receive.

According to another example of the disclosure, a device for facilitating item exchanges comprises one or more processors configured to provide an interface enabling a user to associate information with an item the user owns, provide an interface enabling the user to associate information with an item the user wants to receive, determine whether information associated with the item the user wants to receive matches information associated with an item another user owns, and provide an interface enabling the user to pursue a transaction with another user owning an item associated with information matching the information associated with the item the user wants to receive.

According to another example of the disclosure a non-transitory computer-readable storage medium has instructions stored thereon that upon execution cause one or more processors of a device to provide an interface enabling a user to associate information with an item the user owns, provide an interface enabling the user to associate information with an item the user wants to receive, determine whether information associated with the item the user wants to receive matches information associated with an item another user owns, and provide an interface enabling the user to pursue a transaction with another user owning an item associated with information matching the information associated with the item the user wants to receive.

According to another example of the disclosure an apparatus for facilitating a multi-user item exchange comprises means for providing an interface enabling a user to associate information with an item the user owns, means for providing an interface enabling the user to associate information with an item the user wants to receive, means for determining whether information associated with the item the user wants to receive matches information associated with an item another user owns, and means for providing an interface enabling the user to pursue a transaction with another user owning an item associated with information matching the information associated with the item the user wants to receive.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating an example system that may implement one or more techniques of this disclosure.

FIG. 2 is a block diagram illustrating an example of a computing device that may implement one or more techniques of this disclosure.

FIG. 3 is a block diagram illustrating a detailed view of an example system that may implement one or more techniques of this disclosure.

FIG. 4 is an example of a graphical user interface according to one or more techniques of this disclosure.

FIG. 5 is an example of a graphical user interface according to one or more techniques of this disclosure.

FIG. 6 is an example of a graphical user interface according to one or more techniques of this disclosure.

FIG. 7 is an example of a graphical user interface according to one or more techniques of this disclosure.

FIG. 8 is an example of a graphical user interface according to one or more techniques of this disclosure.

FIG. 9 is an example of a graphical user interface that may be provided by a computing device to implement one or more techniques of this disclosure.

FIG. 10 is an example of a graphical user interface that may be provided by a computing device to implement one or more techniques of this disclosure.

FIG. 11 is an example of a graphical user interface that may be provided by a computing device to implement one or more techniques of this disclosure.

FIG. 12 is an example of a graphical user interface that may be provided by a computing device to implement one or more techniques of this disclosure.

FIG. 13 is an example of a graphical user interface that may be provided by a computing device to implement one or more techniques of this disclosure.

FIG. 14 is an example of a graphical user interface that may be provided by a computing device to implement one or more techniques of this disclosure.

### DETAILED DESCRIPTION

In general this disclosure describes techniques for exchanging items. In particular, this disclosure describes example techniques for facilitating multi-user transactions. Historically, bartering has been a popular type of transaction. Although the majority of items exchanged today are exchanged for a monetary value, bartering is increasing in popularity. Typical online auction and classified services are designed to facilitate item/service for cash transactions and merely allow users to create a posting and describe in the posting what they would like in exchange for the item. Although some online auction and classifieds services allow users to describe a particular item that they would like to receive in exchange for their item, current online auction and classified systems do not efficiently facilitate bartering transactions. That is, current online auction and classified services do not generate and present possible transactions to users. Further, current online auction and classified services do not facilitate sophisticated multi-party bartering transactions. The systems and methods described herein may enable users to efficiently execute complex bartering transactions.

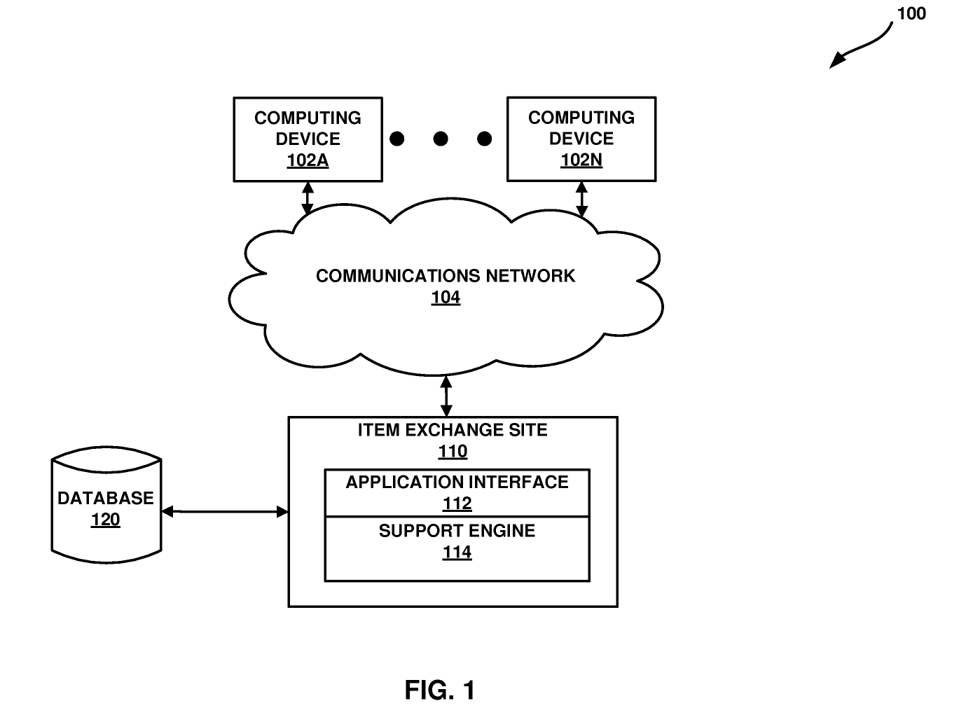

FIG. 1 is a block diagram illustrating an example system that may implement one or more techniques of this disclosure. System 100 may be configured to facilitate the exchange of items in accordance with the techniques described herein. In the example illustrated in FIG. 1, system 100 includes one or more computing devices 102A-102N, communications network 104, and item exchange site 110. Item exchange site 110 may include application interfaces 112 and support engine 114. Further, as illustrated in FIG. 1, item exchange site 110 may be connected to database 120. System 100 may include software modules operating on one or more servers. Software modules may be stored in a memory and executed by a processor. Servers may include one or more processors and a plurality of internal and/or external memory devices. Examples of memory devices include file servers, an FTP servers, network attached storage (NAS) devices, a local disk drive, or any other type of device or storage medium capable of storing data. Storage medium may include Blu-ray discs, DVDs, CD-ROMs, flash memory, or any other suitable digital storage media. When the techniques described herein are implemented partially in software, a device may store instructions for the software in a suitable, non-transitory computer-readable medium and execute the instructions in hardware using one or more processors.

System 100 represents an example of a system that may be configured to facilitate the exchange of items by users of computing devices, such as computing devices 102A-102N. As used herein, the term user may refer to a user and/or a subscriber of an item exchange service. In the example illustrated in FIG. 1, computing devices 102A-102N may respectively include any device configured to transmit data to and receive data from communication network 104. For example, computing devices 102A-102N may be equipped for wired and/or wireless communications and may include desktop or laptop computers, mobile devices, tablet computers, smartphones, cellular telephones, set top boxes, and personal gaming devices.

Communications network 104 may comprise any combination of wireless and/or wired communication media. Communication network 104 may include routers, switches, base stations, or any other equipment that may be used to facilitate communication between various devices and sites. Communication network 104 may form part of a packet-based network, such as a local area network, a wide-area network, or a global network such as the Internet. Communication network 104 may operate according to one or more communication protocols, such as, for example, a Global System Mobile Communications (GSM) standard, a code division multiple access (CDMA) standard, a 3rd Generation Partnership Project (3GPP) standard, an Internet Protocol (IP) standard, a Wireless Application Protocol (WAP) standard, and/or an IEEE standard, such as, one or more of the 802.11 standards, as well as various combinations thereof.

As illustrated in FIG. 1, item exchange site 110 is connected to communications network 104. Item exchange site 110 is configured to support the operation of an online item exchange service. In the example illustrated in FIG. 1, item exchange site 110 includes application interface 112 and support engine 114. Application interface 112 and support engine 114 may be implemented as any of a variety of suitable circuitry, such as one or more microprocessors, digital signal processors (DSPs), application specific integrated circuits (ASICs), field programmable gate arrays (FPGAs), discrete logic, software, software modules, hardware, firmware or any combinations thereof.

Application interface 112 may be configured to provide an interface between item exchange site 110 and one or more of computing devices 102A-102N. For example, application interface 112 may provide a log-in page for users of computing devices 102A-102N. Further, application interface 112 may generate the graphical user interfaces described herein. Support engine 114 may be configured to provide support services associated with item exchange site 110. For example, support engine 114 may validate user credentials entered through a log-in page. Further, as described in detail below, support engine 114 may facilitate multi-user item exchanges. As illustrated in FIG. 1, database 120 is connected to item exchange site 110. Database 120 may include any of the memory devices described above. Database 120 may store information associated with the operation of item exchange site 110. For example database 120 may store user account information and information related to items.

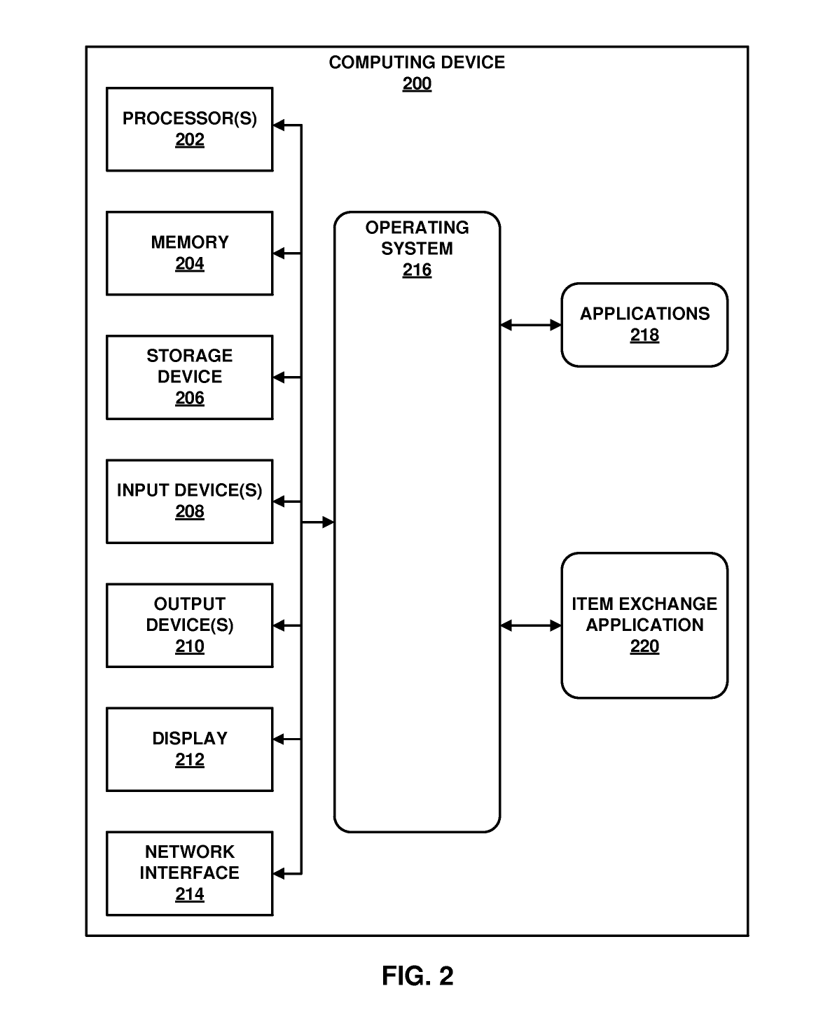

FIG. 2 is a block diagram illustrating an example of a computing device that may implement one or more techniques of this disclosure. Computing device 200 is an example of a computing device that may be configured to transmit data to and receive data from communication network 104 and execute one or more applications (e.g., item exchange application 220). Computing device 200 may include or be part of a portable computing device (e.g., a mobile phone, netbook, laptop, personal data assistant (PDA), or tablet device) or a stationary computer (e.g., a desktop computer, or set-top box), or may be another computing device. Computing device 200 includes processor(s) 202, memory 204, storage device 206, input device(s) 208, output device(s) 210, display 212, and network interface 214. Each of processor(s) 202, memory 204, storage device 206, input device(s) 208, output device(s) 210, display 212, and network interface 214 may be interconnected (physically, communicatively, and/or operatively) for inter-component communications. Operating system 216, applications 218, and item exchange application 220 may be executable by computing device 200. It should be noted that although example computing device 200 is illustrated as having distinct functional blocks, such an illustration is for descriptive purposes and does not limit computing device 200 to a particular hardware architecture. Functions of computing device 200 may be realized using any combination of hardware, firmware and/or software implementations.

Processor(s) 202 may be configured to implement functionality and/or process instructions for execution in computing device 200. Processor(s) 202 may be capable of retrieving and processing instructions, code, and/or data structures for implementing one or more of the techniques described herein. Instructions may be stored on a computer readable medium, such as memory 204 or storage device 206. Processor(s) 202 may be digital signal processors (DSPs), general purpose microprocessors, application specific integrated circuits (ASICs), field programmable logic arrays (FPGAs), or other equivalent integrated or discrete logic circuitry.

Memory 204 may be configured to store information that may be used by computing device 200 during operation. As described above, memory 204 may be used to store program instructions for execution by processor(s) 202 and may be used by software or applications running on computing device 200 to temporarily store information during program execution. For example, memory 204 may store instructions associated with operating system 216, applications 218, and item exchange application 220 or components thereof, and/or memory 204 may store information associated with the execution of operating system 216, applications 218, and item exchange application 220. Memory 204 may be described as a non-transitory or tangible computer-readable storage medium. In some examples, memory 204 may provide temporary memory and/or long-term storage. In some examples, memory 204 or portions thereof may be described as volatile memory or non-volatile memory. Volatile memory may refer to memory that does not maintain stored contents when computing device 200 is powered down. Examples of volatile memories include random access memories (RAM), dynamic random access memories (DRAM), and static random access memories (SRAM). Non-volatile memory may refer to memory that does maintain stored contents when computing device 200 is powered down. Examples of such non-volatile storage elements may include magnetic hard discs, optical discs, floppy discs, flash memories, or forms of electrically programmable memories (EPROM) or electrically erasable and programmable (EEPROM) memories.

Storage device 206 represents memory of computing device that may be configured to store relatively larger amounts of information for relatively longer periods of time than memory 204. Similar to memory 204, storage device 206 may also include one or more non-transitory or tangible computer-readable storage media. Storage device 206 may be internal or external memory and in some examples may include volatile and/or non-volatile storage elements.

Input device(s) 208 may be configured to receive input from a user operating computing device 200. Input from a user may be generated as part of a user running one or more software applications, such as applications 218 and/or item exchange application 220. Input device(s) 208 may include a touch-sensitive screen, track pad, track point, mouse, a keyboard, a microphone, video camera, or any other type of device configured to receive input from a user. In one example, input device(s) 208 may generate one or more signals corresponding to the coordinates of a position touched on a touchscreen of computing device 200. These signals may be provided as information to components of computing device 200 (e.g., processor 202, or operating system 216) in conjunction with the execution of applications 218 and/or item exchange application 220.

Output device(s) 210 may be configured to provide output to a user operating computing device 200. Output may tactile, audio, or visual output generated as part of a user running one or more software applications, such as applications 218 and/or item exchange application 220. Output device(s) 210 may include a touch-sensitive screen, sound card, a video graphics adapter card, or any other type of device for converting a signal into an appropriate form understandable to humans or machines. Additional examples of an output device(s) 210 may include a speaker, a cathode ray tube (CRT) monitor, a liquid crystal display (LCD), or any other type of device that can provide output to a user. In some examples, output device(s) 210 may be external to computing device 200 and may be operatively coupled to computing device 200 using a standardized communication protocol, such as for example, Universal Serial Bus protocol (USB) or High-Definition Multimedia Interface (HDMI).

In the example illustrated in FIG. 2, computing device 200 includes display 212. In the example where computing device 200 is a mobile device, display 212 may be an integrated touch-screen display. For example, display 212 may be an LCD or organic light emitting diode (OLED) display configured to receive user touch inputs, such as, for example, taps, drags, and pinches, and display appropriate graphics. Thus, display 212 may be considered as a particular type of input and output device of computing device 200. Display 212 may be configured to allow a user to interact with item exchange application 220, as describe in detail below.

Network interface 214 may be configured to enable computing device 200 to communicate with external devices via one or more networks, such as communications network 104. Network interface 214 may be a network interface card, such as an Ethernet card, an optical transceiver, a radio frequency transceiver, or any other type of device that can send and receive information. Network interface 214 may be configured to operate according to one or more of the communication protocols described above with respect to communications network 104.

Operating system 216 may be configured facilitate the interaction of applications, such as application 218 and item exchange application 220, with processor(s) 202, memory 204, storage device 206, input device(s) 208, output device(s) 210, display 212, network interface 214 and other hardware components of computing device 200. Operating system 216 may be an operating system designed to be installed on laptops and desktops. For example, operating system 216 may be a Windows operating system, Linux, or Mac OS. In another example, if computing device 200 is a mobile device, such as a smartphone or a tablet, operating system 216 may be one of Android, iOS or a Windows mobile operating system.

Applications 218 may include any applications implemented within or executed by computing device 200 and may be implemented or contained within, operable by, executed by, and/or be operatively/communicatively coupled to components of computing device 200, e.g., processor(s) 202, memory 204, and network interface 214. Applications 218 may include instructions that cause processor(s) 202 of computing device 200 to perform particular functions. Applications 218 may include algorithms which are expressed in computer programming statements, such as, for loops, while-loops, if-statements, do-loops, etc. Item exchange application 220 may be an application that allows computing device 200 to perform functionality associated with item exchange system 100. In one example, item exchange application 220 may be a web browser, such as, for example, Internet Explorer of Google Chrome and any associated supporting software modules (e.g., plugins, such as, for example, Abode Flash). In one example, where computing device 200 is a mobile device (e.g., a smart phone or a tablet computing device), item exchange application 220 may be a dedicated application designed for a mobile operating system.

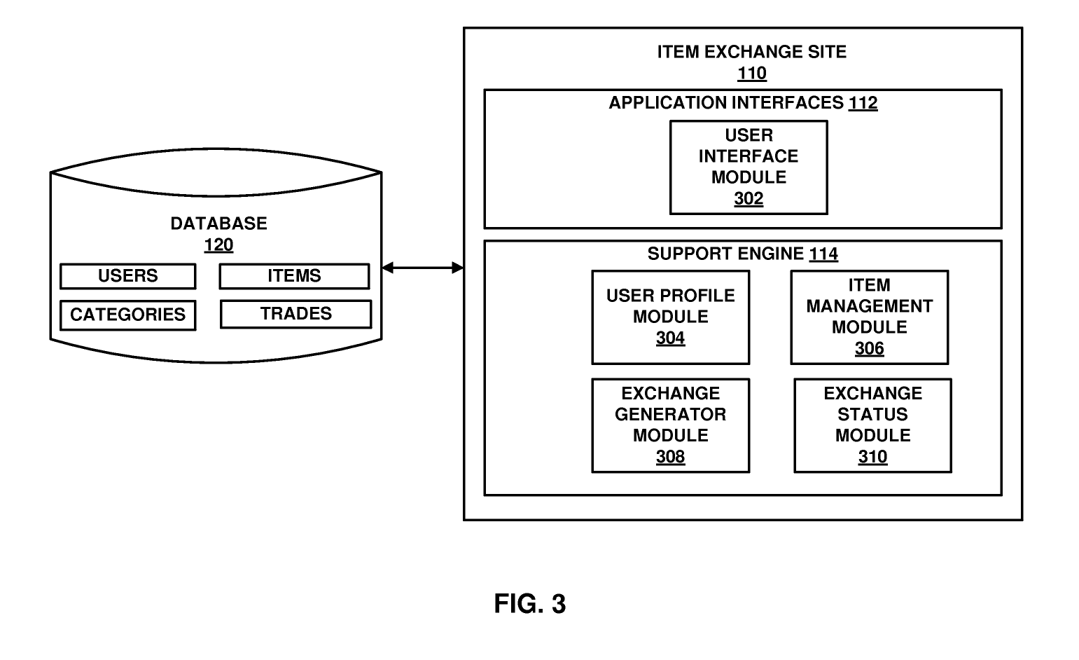

FIG. 3 is a block diagram illustrating a detailed view of an example system that may implement one or more techniques of this disclosure. As illustrated in FIG. 3, application interface 112 includes user interface module 302 and support engine 114 includes user profile module 304, item management module 306, exchange generator module 308, and exchange status module 310. Application interfaces 112, support engine 114, and modules thereof may be implemented as any of a variety of suitable circuitry, such as one or more microprocessors, digital signal processors (DSPs), application specific integrated circuits (ASICs), field programmable gate arrays (FPGAs), discrete logic, software, software modules, hardware, firmware or any combinations thereof.

In one example, application interfaces 112, support engine 114, and modules thereof may be implemented using one or more programming languages. Examples of programming languages include Hypertext Markup Language (HTML), Dynamic HTML, Extensible Markup Language (XML), Extensible Stylesheet Language (XSL), Document Style Semantics and Specification Language (DSSSL), Cascading Style Sheets (CSS), Synchronized Multimedia Integration Language (SMIL), Wireless Markup Language (WML), Java™, Jini™, C, C++, Perl, UNIX Shell, Visual Basic or Visual Basic Script, Virtual Reality Markup Language (VRML), ColdFusion™ and other compilers, assemblers, and interpreters. In one example, item exchange site 110 may run according to a ColdFusion™ 9.0 web environment and may use JavaScript and jQuery in addition to ColdFusion™.

As illustrated in FIG. 3, database 120 may include the following example types of data: data associated with users, data associated with items, data associated with categories, and data associated with trades. In one example, data associated with users may include an email address, a password, a username, a first name, a last name, a physical address, and/or a phone number. Further, data associated with a user may include a user's trading preferences, a user's trade ratings, and a user's trader level. In one example, data associated with items may include an identifier (e.g., a unique serial number), a title, a description, keywords, images, a value, a status (e.g., a user wants to offer this item or a user wants to receive this item) and/or a location. In one example, data associated with categories may include a list of categories and any associated sub-categories. For example, categories may include cars and boats and sub-categories for cars may include sedans, SUV, and trucks. There may be multiple levels of sub-categories for a particular category (e.g., engine type).

In one example, data associated with trades may include data associated with items a user wants, trade level information, and trade status information. As described in detail below, item exchange site 110 may be configured to facilitate trades between multiple users (i.e., a multi-user trade), trade level information may include information to support a multi-user trade. In one example, a multi-user trade may be referred to as a trade circle. In one example, possible trade statuses may include proposed, not seen, investigating, interested, active, completed, cancelled, and/or declined. Data stored in database 120 may be accessed and updated by support engine 114 to provide application interfaces 112 and support functionality associated with a user interacting with a graphical user interface, as described in detail below. In one example, database 120 may include data residing in a Microsoft SQL environment. In some examples database 120 may be configured such that data is exportable to XML or JSON formats. It should be noted that types of data as described herein are described for illustrative purposes and the techniques described herein may be applicable for other types of data structures.

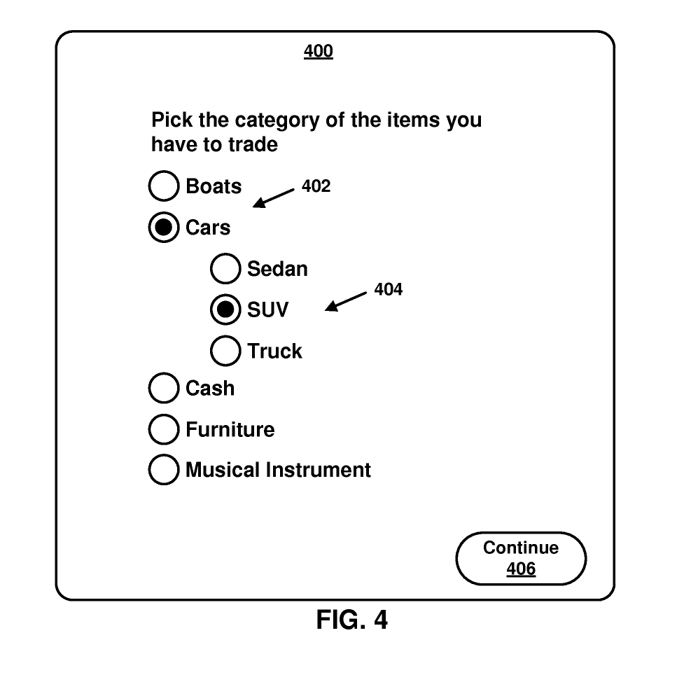

User interface module 302 may be configured to provide graphical user interfaces (GUIs) to a computing device. It should be noted that providing a graphical user interface may include providing information to a computing device, such that a computing device may generate a graphical user interface from the provided information. In one example, user interface module 302 may be configured to provide the graphical user interfaces described in FIGS. 4-14 to one or more of computing devices 102A-102N. As described in detail below, the graphical user interfaces illustrated in FIGS. 4-14 may be provided to a user in order to enable a user to execute item exchanges.

User profile module 304 may be configured to process information relating to one or more users of item exchange site 110. As described above, data associated with users may include an email address, a password, a username, a first name, a last name, a physical address, and/or a phone number. User profile module 304 may be configured to receive user data from user interface module 302 and provide user data to database 120 in an appropriate format. As further described above, data associated with a user may include a user's trading preferences, a user's trade ratings, and a user's trader level. In one example, a user's trade rating may include feedback from other users. For example, users may rate one another on a scale of 1-10 for each trade participated in. User profile module 304 may be configured to generate a user's trader level based on trade ratings. In one example, possible user trader levels may include a one star rating through a five star rating. In one example, user profile module 304 may determine a trader level based on a minimum number of trades with a minimum trade rating. For example, a three star trade rating may be achieved by a user by executing five trades with a minimum rating of five.

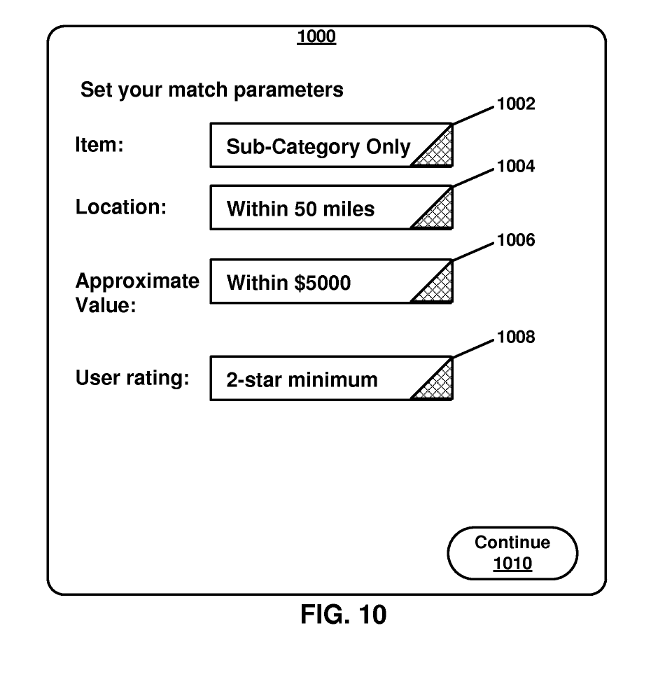

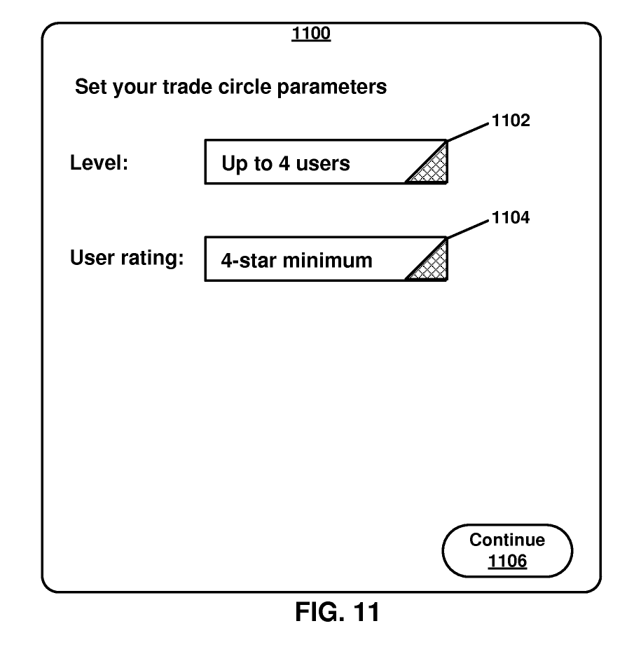

A user's trading preferences may include information based on the types of trades a user wish to participate in. For example, a user may wish to only participate in trades with users having a minimum trader level. Further, users may be able to block other users such that further trades with a blocked user are not suggested. As described in detail below, in one example, users may set one or more filter values to control which types of trades are proposed to a user. In one example, user interface module 302 may provide graphical user interfaces that enable a user to set trading preferences. In one example, the graphical user interfaces described with respect to FIG. 10 and FIG. 11 may be provided to a user to enable to set trade preferences.

Item management module 306 may be configured to process information relating to items users of item exchange site 110 wish to trade. Items users wish to trade may include items users own and items that users wish to receive in exchange for items that they own. As described above, data associated with items may include an identifier, a title, a description, keywords, images, a value, a status, and/or a location. Item management module 306 may be configured to receive item data from user interface module 302 and provide item data to database 120 in an appropriate format. As described above, database 120 may include a list of categories and associated sub-categories. In one example, item management module 304 may be configured to associate an item with one or more categories. Further, item management module 304 may be configured to associate an item with one or more users (e.g., as an item a user has and/or an item a user wants). In one example, user interface module 302 may provide graphical user interfaces that enable users to provide information for items they wish to trade. In one example, the graphical user interfaces described with respect to FIGS. 4-8 may be provided to a user to enable a user to provide information they wish to trade.

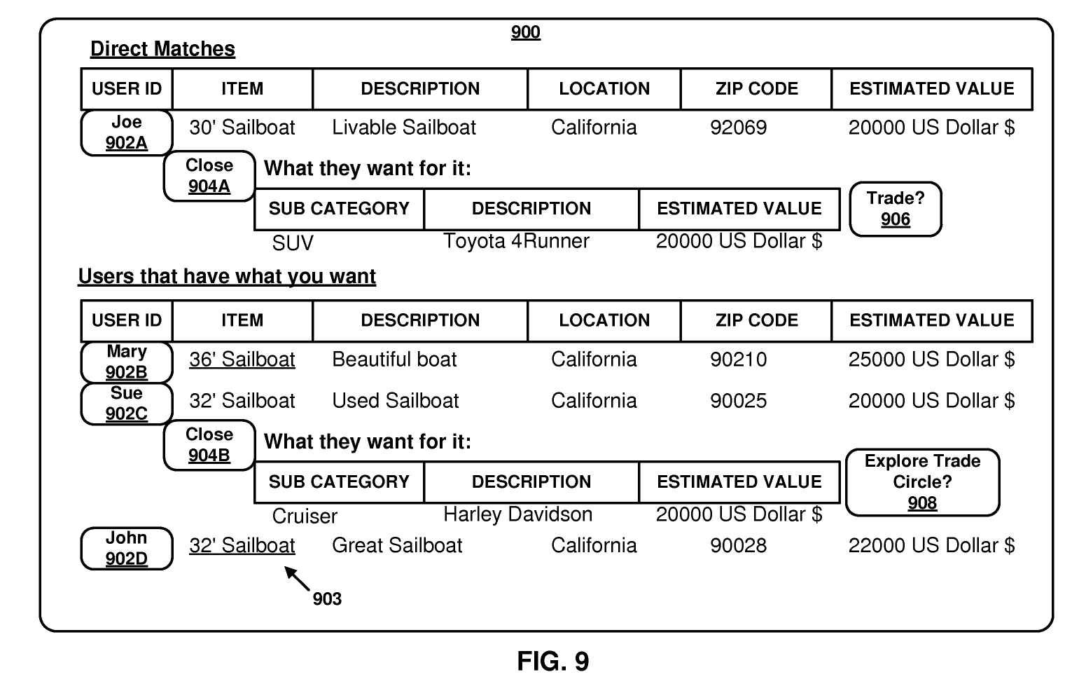

Exchange generator module 308 may be configured to process information relating to possible transactions. As described above, users of item exchange site 110 may provide information associated with their trade preferences, information associated with items they own, and information associated with items they wish to receive in exchange for the items they own. Further, each user may have a trader level. Exchange generator module 308 may be configured to process user data and item data and present one or more possible trades to a user. For example, exchange generator module 308 and/or user interface module 302 may provide a user with a graphical user interface including a list of possible trades. In one example, the graphical user interfaces described with respect to FIGS. 9-13 may be provided to a user to enable a user to facilitate a possible trade.

As described above, possible trade statuses may include proposed, not seen, investigating, interested, active, completed, cancelled, and/or declined. A proposed status may indicate that a user proposed a trade. A not seen status may indicate that a user has not reviewed a proposed trade. An investigating status may indicate that a user has reviewed a possible trade. An interested status may indicate that a user is interested in a trade, but not committed to a trade. For example, an interested trade status may indicate that a user contacted another user regarding a proposed trade. An active status may indicate that a user has committed to a trade and/or a portion of a trade has been completed (e.g., one out of two items exchanged). A completed status may indicate that a trade has been completed (e.g., all items exchanged). In some examples, a completed status may only be given once all users have provided feedback for the other users that participated in a trade. A cancelled status may indicate that an active trade has been cancelled. A declined status may indicate that a user is not interested in a possible trade.

Exchange status module 310 may be configured to process information relating to trade statuses. Exchange status module 310 may be configured to receive user data from user interface module 302 and provide trade status data to database 120 in an appropriate format. For example, user interface module 302 may receive a request from a user to view a proposed trade and exchange status module 310 may update a trade status from not seen to investigating based on the request. In one example, information provided by users using the graphical user interfaces described with respect to FIGS. 9-14 may be used by exchange status module 310 to determine a trade status.

As described above, graphical user interfaces described with respect to FIGS. 4-8 may be provided to a user to enable a user to provide information regarding items that they wish to trade. FIGS. 4-8 illustrate examples of graphical user interfaces that may be provided by a computing device to implement one or more techniques of this disclosure. Graphical user interface 400 is an example of a graphical user interface that enables a user to associate a category and a sub-category with an item. In one example, graphical user interface 400 may be provided to a user when a user indicates that they want to trade an item from an initial menu (initial menu not shown). As illustrated in FIG. 4, graphical user interface 400 includes item category selection field 402, item sub-category selection field 404 and continue icon 406. Item category selection field 402 enables a user to associate a category with an item. In the example illustrated in FIG. 4, a user may toggle a radio button corresponding to a category that the user believes to accurately describe the user's item. In addition to the categories illustrated in FIG. 4, graphical user interface 400 may include several addition categories (e.g., appliances, electronics, etc.). It should be noted that for the sake of brevity an exhaustive list of possible categories is not described herein. It should also be noted that in the example illustrated in FIG. 4, cash is included as a category. In this manner, in addition to facilitating bartering transactions, system 100 may be configured to facilitate monetary transactions.

In the example illustrated in FIG. 4, upon a user selecting cars category, a user may select a sub-category from sub-category selection field 404 to further associated categories with a user's item. In the example illustrated in FIG. 4, sub-category selection field appears upon a category being selected. In one example, sub-category selection field 404 may appear as a separate graphical user interface. It should be noted that in some examples there may be multiple levels of sub-categories for a particular category. Once a user selects categories and sub-categories, a user may activate continue icon 406. In one example, upon a user activating continue icon 406, category and sub-category selection data may be sent to item management module 306 and item management module 306 may process selection data in order to generate item data for storage in in database 120.

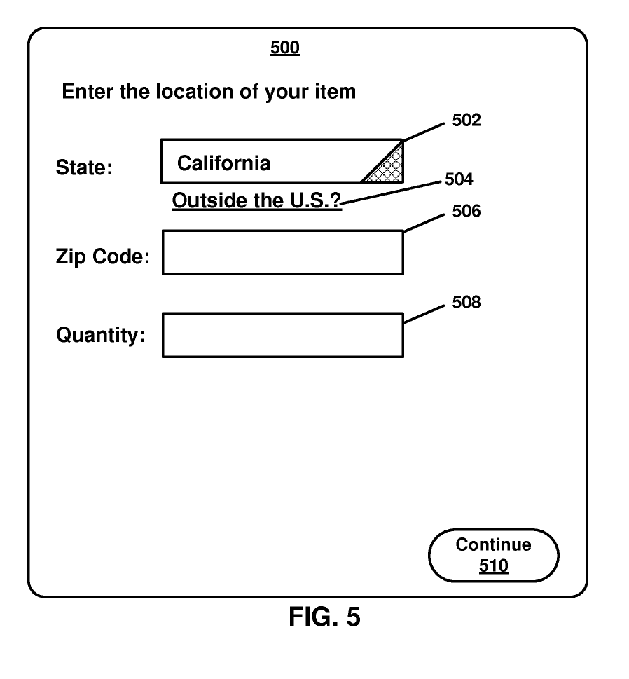

Further, upon a user activating continue icon 406, one or more additional graphical user interfaces may be presented to a user. In one example, graphical user interface 500 illustrated in FIG. 5 may be presented to a user. Graphical user interface 500 is an example of a graphical user interface that may be provided by a computing device to implement one or more techniques of this disclosure. Graphical user interface 500 is an example of a graphical user interface that enables a user to associate a location and quantity with an item. As illustrated in FIG. 5, graphical user interface 500 includes state selection entry field 502, “outside the U.S.?” hyperlink 504, zip code entry field 506, quantity entry field 508, and continue icon 510.

State selection field 502 may enable a user to select a state where the item is located. In the example illustrated in FIG. 5, state selection entry field 502 may include a drop down list including all 50 states. “Outside the U.S.?” hyperlink 504 may provide a graphical user interface that enables a user to specify a location outside of the United States. Zip Code entry field 506 may be configured to enable a user to specify a Zip Code of where an item is located. Quantity entry field 508 may be configured to enable a user to specify a quantity with an item. For example, a user may have a lot of items (e.g., 500 widgets) that the user wishes to trade. Once a user provides location and quantity data, a user may activate continue icon 510. In one example, upon a user activating continue icon 510, location and quantity data may be sent to item management module 306 and item management module 306 may process the data in order to generate item data for storage in in database 120.

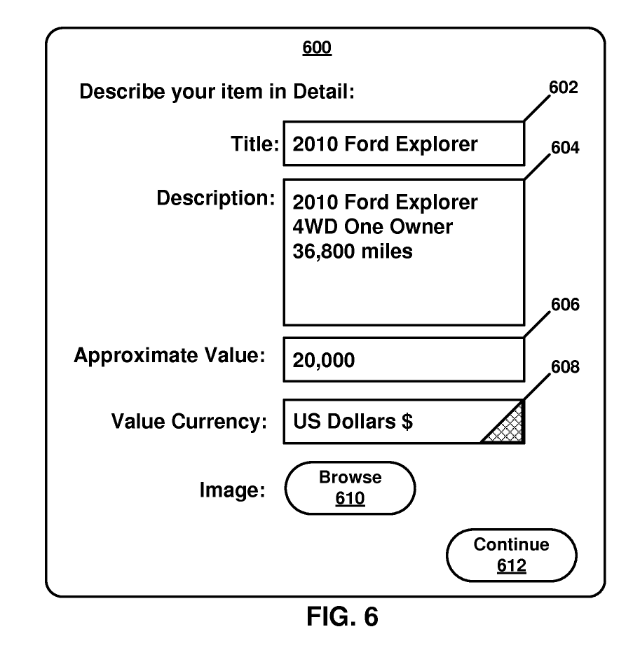

Further, upon a user activating continue icon 510, one or more additional graphical user interfaces may be presented to a user. In one example, graphical user interface 600 illustrated in FIG. 6 may be presented to a user. Graphical user interface 600 is an example of a graphical user interface that may be provided by a computing device to implement one or more techniques of this disclosure. Graphical user interface 600 is an example of a graphical user interface that enables a user to associate detailed information with an item. As illustrated in FIG. 6, graphical user interface 600 includes title entry text box 602, description entry text box 604, approximate value entry field 606, value currency entry field 608, image browse icon 610, and continue icon 612. Title entry text box 602 may be configured to enable a user to associate a title with an item. Description entry text box 604 may be configured to enable a user to associate a description with an item. In one example, a user may associate one or more keywords with an item.

Approximate value entry field 606 may be configured to enable a user to associate an approximate value with an item. Value currency entry field 608 may enable a user to select a currency of the specified approximate value. By allowing a user to specific one of a plurality of value currencies, system 100 may facilitate international transactions. Image browse icon 610 may be configured to enable a user to upload an image associated with an item to item exchange site 110. Once a user provides detailed item data, a user may activate continue icon 612. In one example, upon a user activating continue icon 612, detailed item data may be sent to item management module 306 and item management module 306 may process detailed item data in order to generate item data for storage in in database 120. As described in detail below, item data may be used by exchange generator module 308 to present a user with possible transactions. For example, exchange generator module 308 may extract keywords from a description in order to match items one user wants with items another user has. In one example, a user may bundle one or more items that they have for a possible transaction. That is, a user may associate information with multiple items that a user owns and combine the items in order to generate a higher total approximate value. For example, if a wants an item with an approximate value of $20,000 and owns one item with an approximate value of $15,000 and owns a second item with an approximate value of $5,000, the user may be able to indicate that both of the items be included for a possible transaction with another user.

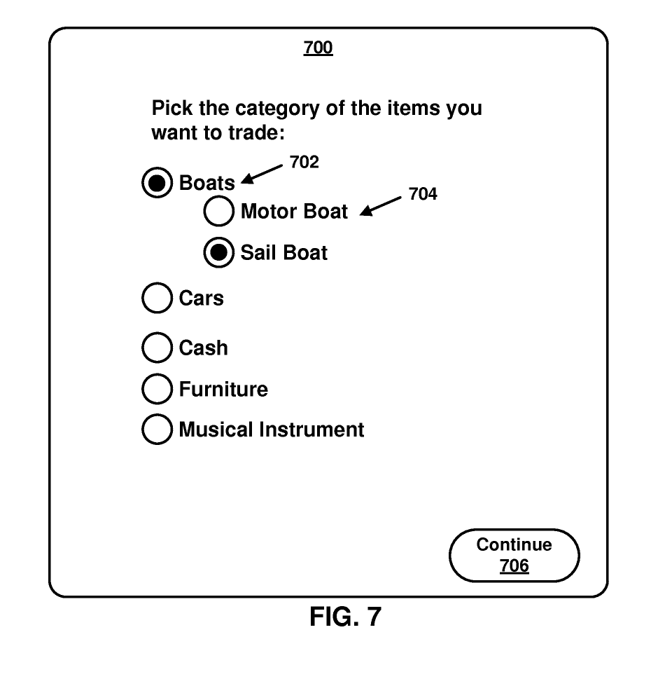

Upon a user activating continue icon 612, one or more additional graphical user interfaces may be presented to a user. In one example, graphical user interface 700 illustrated in FIG. 7 may be presented to a user. Graphical user interface 700 is an example of a graphical user interface that may be provided by a computing device to implement one or more techniques of this disclosure. Graphical user interface 700 is an example of a graphical user interface that enables a user to associate a category and a sub-category with an item a user desires in exchange for his or her items. As illustrated in FIG. 7, graphical user interface 700 includes category entry field 702, sub-category entry field 704, and continue icon 706. In a manner similar to that described above with respect to FIG. 4, a user may associate a category and one or more sub-categories with a desired item using category entry field 702 and sub-category entry field 704. Once a user selects categories and sub-categories, a user may activate continue icon 706. In one example, upon a user activating continue icon 706, category and sub-category selection data may be sent to item management module 306 and item management module 306 may process selection data in order to generate item data for storage in in database 120.

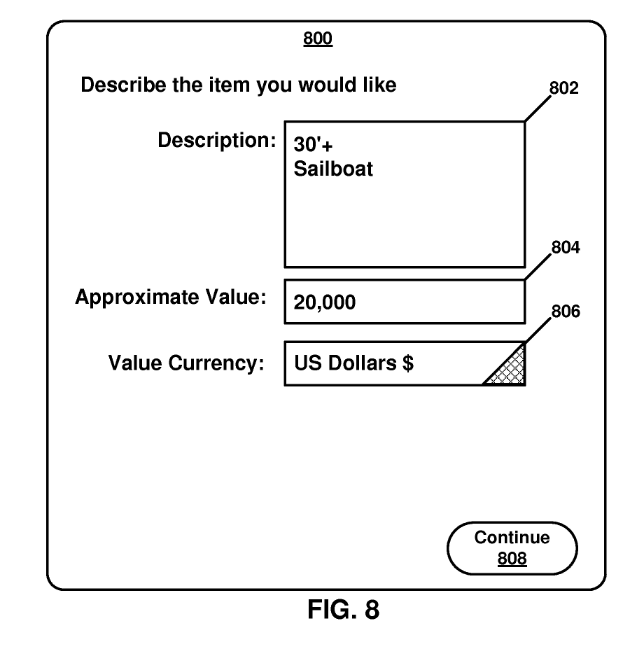

Further, upon a user activating continue icon 706, one or more additional graphical user interfaces may be presented to a user. In one example, graphical user interface 800 illustrated in FIG. 8 may be presented to a user. Graphical user interface 800 is an example of a graphical user interface that may be provided by a computing device to implement one or more techniques of this disclosure. Graphical user interface 800 is an example of a graphical user interface that enables a user to associate detailed information with a desired item. As illustrated in FIG. 8, graphical user interface 800 includes description entry field 802, approximate value entry field 804, value currency entry field 806, and continue icon 808. In a manner similar to that described above with respect to FIG. 6, a user may associate detailed information with a desired item using description entry field 802, approximate value entry field 804, and value currency entry field 806. Once a user provides detailed item data, a user may activate continue icon 808. In one example, upon a user activating continue icon 808, detailed item data may be sent to item management module 306 and item management module 306 may process detailed item data in order to generate item data for storage in in database 120.

As described above, exchange generator module 308 may be configured to process information relating to possible transactions. Exchange generator module 308 may receive information associated with items users own and information associated with items users want and generate possible transactions. For example, if a user wants an item included in a particular sub-category having a particular approximate value, exchange generator module 308 may search item data for items included in the particular sub-category and having an approximate value within a range of the particular approximate value. That is, exchange generator module 308 may match an item one user wants with items other users have. Exchange generator 308 may be configured to match any and all combination of item data described herein. For example, exchange generator 308 may be configured to match any and all combinations of categories, sub-categories, location data, quantity data, keywords included in item titles and descriptions, and/or approximate values.

In one example, upon finding an item matching an item that a user wants, exchange generator module 308 may generate possible transactions based on an item the user of the matching item wants. That is, exchange generator module 308 may determine whether a user having a matching item wants an item matching the item the other user has. In one example, this type of transaction may be referred to as a direct match. Further, item exchange module 308 may determine whether a multi-user trade is possible. That is, if User A has item X and wants item Y, User B has item Y and wants item Z, and User C has item Z and wants item X, exchange generator 308 may determine that a transaction between User B and User C for item Y and item Z and a subsequent transaction between User C and User A for item Y and item X may allow all users to exchange the items they have for the items they want. In one example, this type of transaction may be referred to as a level-3 transaction (three users/three items). In one example, in addition to being configured to determine whether level-3 transactions are possible, exchange generator 308 may be configured to determine whether level-4 (four users/four items) transactions and/or whether level-5 transactions (five users/five items) are possible. In practice, if there are a significant amount of users of system 100, the majority of users may be able to exchange the item they have for the item they want without exceeding a level-5 transaction. As described in detail below, possible trades may be presented to a user based on a user's trade preferences.

In one example, exchange generator module 308 may provide possible transaction information to user interface module 302 and user interface module 302 may provide graphical user interfaces that provide a user with information regarding possible transactions. In one example, the graphical user interfaces described with respect to FIGS. 9-13 may be provided to a user to provide a user with information regarding possible trades. In the examples illustrated in FIG. 9-13, a user may have indicated that the user has a 2010 Ford Explorer using graphical user interfaces 400, 500, and 600, described above, and indicated that the user wants a sailboat using graphical user interfaces 700 and 800, as described above. In this example, a plurality of other users may have indicated that they have particular items and want particular items.

As described above, upon a user activating continue icon 808, detailed item data may be sent to item management module 306 and item management module 306 may process detailed item data in order to process item data for storage in in database 120. As further described above, exchange generate module 308 may search item data for matches. Once the matching process is complete, user interface module 302 may generate a graphical user interface presenting results to a user. Graphical user interface 900 illustrated in FIG. 9 is an example of a graphical user interface that may be used to present results to a user. As illustrated in FIG. 9, graphical user interface 900 includes user identifier icons 902A-902D, item expansion hyperlinks 903, close icons 904A-904B, trade icon 906, and explore trade circle icons 908.

As illustrated in FIG. 9, results in graphical user interface 900 are organized based on whether they are a direct match (i.e., a user that has what the user wants and wants what the user has) or a user simply has what the user wants. Upon being presented graphical user interface 900, a user may obtain more information about particular users and particular items. Upon activation, user identifier icons 902A-902D may enable a user to view more detailed information for a particular user (e.g., a profile page including trade ratings). Upon activation, an item expansion hyperlink 903 may provide more information about a particular item. In the example illustrated in FIG. 9, item expansion hyperlinks associated with user Joe's item and user Sue's items have been activated. Further, as illustrated in FIG. 9, upon activation, item expansion hyperlinks 903 may cause trade icons to be displayed (i.e., icons 906 and 908 in FIG. 9). Once an item expansion hyperlink 903 has be activated and more information is presented to a user, a user may activate close icons 904A-904B to collapse the expanded information. It should be noted that in some examples, information provided with respect to the graphical user interface 900 may be provided using multiple graphical user interfaces.

As described above, in addition to generating possible trades based on item matches, exchange generator module 308 may be configured to generate possible trades based on user data. For example, exchange generator module 308 may filter one or more possible trades based on user profile and/or preference information. In one example, user interface module 302 may provide graphical user interfaces that enable a user to set trade preferences and filter possible trades. FIG. 10 and FIG. 11 are examples of graphical user interfaces that may be provided by a computing device to implement one or more techniques of this disclosure. Graphical user interface 1000 is an example of a graphical user interface that enables a user to configure whether an item is consider a match. In one example exchange generator module 308 may be configured to match items without considering user match parameters and then filter which matches are presented to a user based on a user match parameters. In other examples, exchange generator module 308 may be configured apply user match parameters before determine whether an item is a match.

As illustrated in FIG. 10, graphical user interface 1000 includes item filter entry field 1002, location filter entry field 1004, approximate value filter entry field 1006, user rating filter entry field 1008, and continue icon 1010. Item filter entry field 1002 may enable a user to set whether they wish results to include items having a category that matches the item the user wants or items having only a sub-category match that matches the item the user wants. For example, a user may wish to consider all items included in a boats category for a possible transaction or may wish to consider only items included in a sailboats sub-category for a possible transaction. In the example illustrated in FIG. 10, item filter entry field 1002 includes a drop down menu. Location filter entry field 1004 enables a user to set a proximity of an item to a user to be considered a match. In the example illustrated in FIG. 10, location filter entry field 1004 includes a drop down menu. In one example, the proximity increments included in the drop down menu may be 25 mile increments. Approximate value filter entry field 1006 enables a user to set an approximate value range for items to be considered a match. In one example, value ranges may be absolute (e.g., within a dollar amount). In other examples value ranges may be percentages (e.g., within 10%). In the example illustrated in FIG. 10, approximate value filter entry field 1006 includes a drop down menu.

User rating filter entry field 1008 enables a user to set a minimum rating of another user in order for another user's item to be consider for a possible transaction. For example, a user may not wish to trade with users having a rating indicating insufficient trading experience and/or indicating significant negative trade feedback. As described above, in one example, users may be given a rating from one star to five stars. In the example illustrated in FIG. 10, user rating filter entry field 1008 includes a dropdown menu and may include ratings of one star to five stars in whole or half-star increments. Upon a user setting direct match parameters, a user may activate continue icon 1010 and may be presented another graphical user interface. In one example, a user may set match parameters for all transactions. In other examples a user may set match parameters on a transaction-by-transaction basis.

Because multi-user trades may be more complex than direct trades, in order to facilitate transactions, system 100 may enable a user to set preferences for possible multi-user transactions. Graphical user interface 1100 is an example of a graphical user interface that enables a user to configure a user's preferences for multi-level trades. As illustrated in FIG. 11, graphical user interface 1100 includes trade level filter entry field 1102, user rating filter field 1104, and continue icon 1106. As described above, trade levels may be based on a number of users and/or a number of items. Trade level filter entry field 1102 may enable a user to specify a maximum trade level. In the example illustrated in FIG. 11, trade level filter entry field 1102 includes a dropdown menu. In one example, trade level entry field 1102 may allow a user to select one of direct only, up to 3 users, up to 4 users, or up to 5 users. In a manner similar to user rating filter entry field 1008, user rating filter field 1104 enables a user to set a minimum rating of another user in order for another user's item to be consider for a possible transaction. In the example illustrated in FIG. 11, a user rating is specified for all possible trade circles. In other examples, a user rating may be specified individually for each possible trade-level (e.g., 3-star minimum for level-3 transactions and 4-star minimum for level-4 transactions).

Referring again to FIG. 9, trade icon 906 and explore trade circle icon 908 are configured to enable a user to purpose possible transactions presented to the user. Trade icon 906 is configured to enable a user to pursue a direct match transaction. In one example, upon a user activating trade icon 906, item exchange site 110 may enable a user to communicate with another user (i.e., user Joe in this example) in order to express interest in pursuing a transaction. A user may be able to communicate with another user regarding a possible transaction using one or more of an automated email to another user via item exchange site, an automated message to another user via item exchange site 110, and/or a direct email to another user. In one example, user interface module 302 may provide a form fill graphical user interface that enable a user to message another user. In a manner similar to online auction and classified services, system 100 may be configured to allow users to communicate while enabling users to maintain desired levels of privacy. Further, upon activation of trade icon 906, exchange status module 310 may update a trade status. For example, exchange status module 310 may generate data indicating that trade has been proposed.

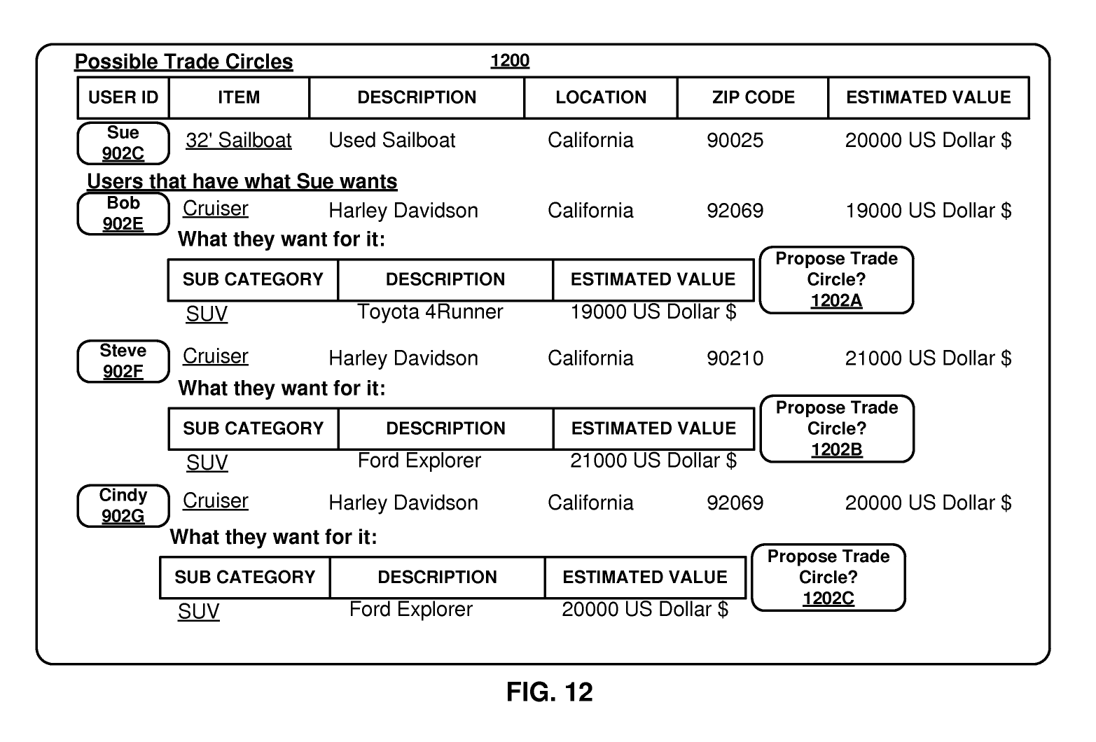

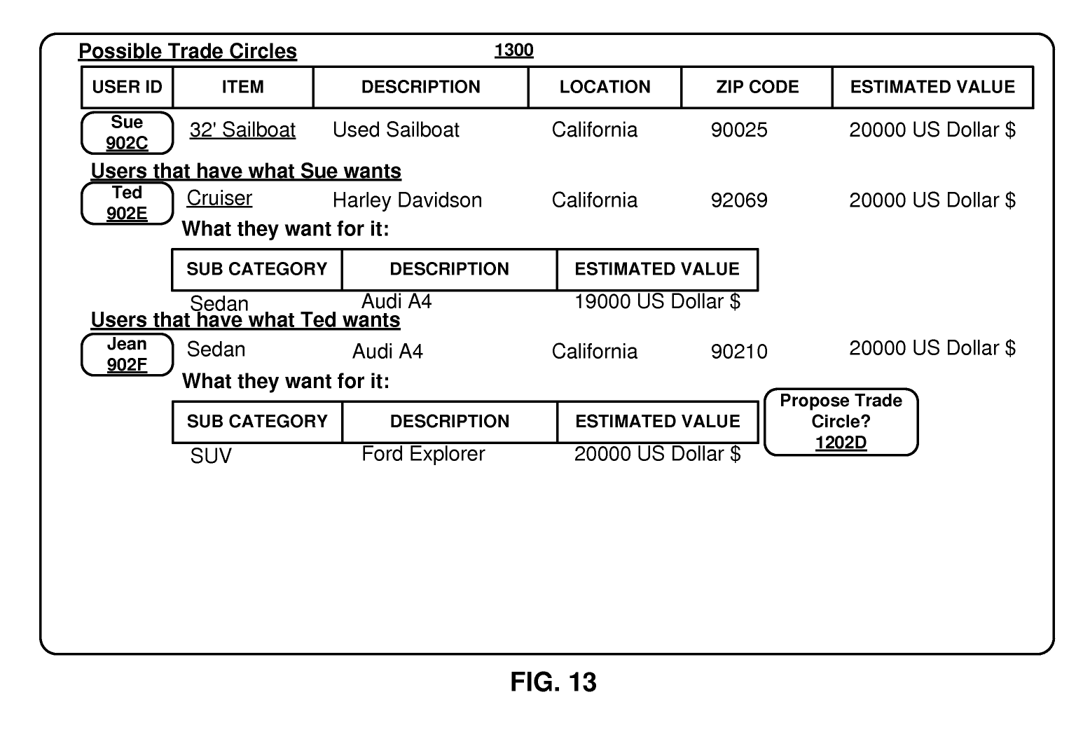

Explore trade circle icon 908 is configured to enable a user to pursue a multi-level transaction. Upon activating explore trade circle icon 908, a user may be presented with one or more graphical user interfaces the enable a user to pursue multi-level trades. In the example illustrated in FIG. 9, upon activation, explore trade circle icon 908 enables a user to pursue a multi-level trade with user Sue. In one example, exchange generator module 308 may provide possible multi-user transaction information to user interface module 302 and user interface module 302 may provide graphical user interfaces that provide a user with information regarding possible multi-level transactions. Graphical user interface 1200 illustrated in FIG. 12 and graphical user interface 1300 illustrated in FIG. 13 are example of a graphical user interfaces that may enable a user to pursue multi-level transactions.

As illustrated in FIG. 12, graphical user interface 1200 displays information regarding the item Sue has and information of users having the item Sue wants. Thus, graphical user interface 1200 enables a user to see how closely the item he or she has matches the items others want and how closely the items the other users have match the item user Sue wants. Thus, graphical user interface 1200 may enable a user to make a judgment of how likely it will be to execute a multi-level trade. As illustrated in FIG. 12, for each of the user having the item Sue graphical user interface 1200 includes propose trade circle icons 1202A-1202C. In the example illustrated in FIG. 12, possible level-3 transactions are presented to a user. In the example illustrated in FIG. 13, possible level-4 transactions are presented to a user. As illustrated in FIG. 13 graphical user interface 1300 includes propose trade circle icon 1202D. Propose trade circle icon 1202 may operate in a similar manner to propose trade circle icons 1202A-1202C, but may simply include one more user for a possible transaction.

In manner similar to that described above with respect to trade icon 906, upon a user activating one or more of propose trade circle icon 1202A-120D, item exchange site 110 may enable a user to communicate with another user in order to express interest in pursuing a transaction. Further, upon activation of one or more of propose trade circle icon 1202A-120D, exchange status module 310 may update a trade statuses. For example, exchange status module 310 may generate data indicating that trade has been proposed. After trades have been proposed, user of item exchange site 110 may communicate with one other in order to complete transaction. In one example, item exchange site 110 may simply provide for initial communication and the users may complete a transaction in a manner that they deem the most efficient. For example, users use telephones to communication with one another and complete a trade by agreeing to meet at a common location. In one example, item exchange site 110 and/or exchange status module 310 may monitor the status of a transaction based on information provided by users and present status information to users.

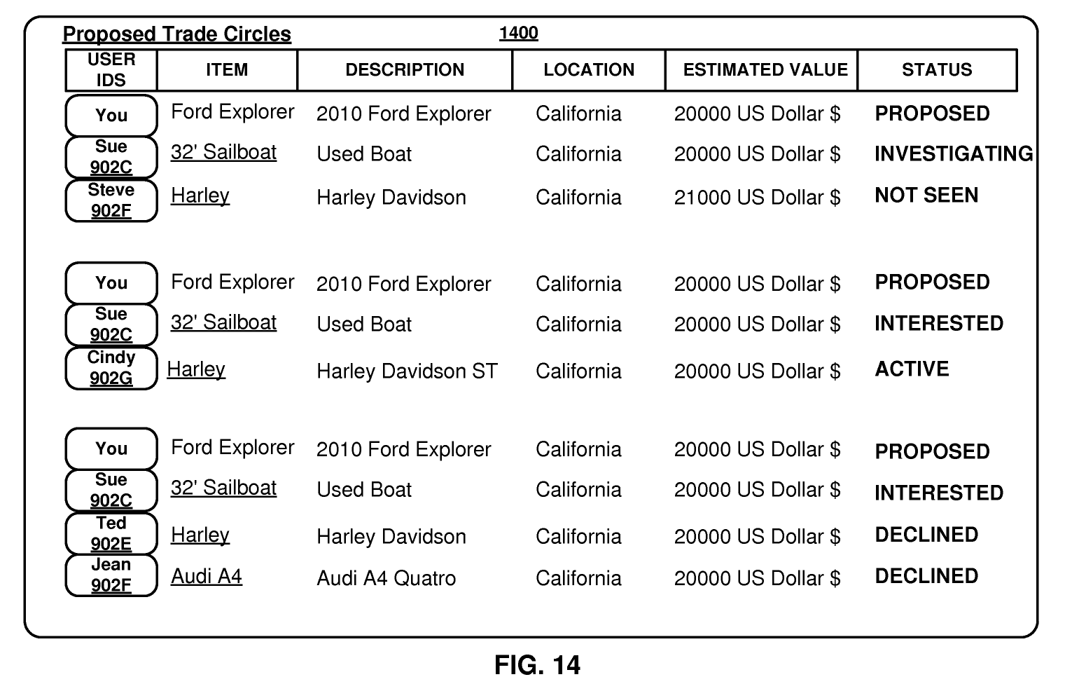

In one example, exchange status module 310 may provide trade status information to user interface module 302 and user interface module 302 may provide graphical user interfaces that enable a user to monitor the status of one or more transactions. Graphical user interface 1400 illustrated in FIG. 14 is an example of a graphical user interface that may enable a user to monitor the status of one or more transactions. As illustrated in FIG. 14, graphical user interface 1400 displays information regarding the status of one or more transactions proposed by a user. As described above, in one example, possible trade statuses may include proposed, not seen, investigating, interested, active, completed, cancelled, and/or declined. In the example illustrated in FIG. 14 trade status is provided for each user include in a possible trade. For example, in the level-3 trade including user Sue and user Steve, graphical user interface 1400 indicates that Sue is investigating the proposed trade and user Steve has not seen the proposed trade. In this manner, graphical user interface 1400 enables a user to monitor one or more multi-user trades.

It should be noted that the example graphical user interfaces described herein are described for illustrative for purpose. The techniques described herein may be generally applicable to other graphical user interface implementations. Further, although the graphical user interfaces described herein are described as including particular elements (e.g., drop down menus, radio buttons, etc.), where appropriate other graphical user elements may be used. For example, a text box field may be used instead of a drop down menu. In this manner, system 100 may be configure to facilitate transaction between users.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

1. A method of facilitating item exchanges between three or more users, the method comprising:
providing a graphical user interface enabling a first user to associate information with an item the first user owns;
providing a graphical user interface enabling the first user to associate information with an item the first user wants to receive;
determining whether information associated with the item the first user wants to receive matches information associated with an item a second user owns; and
providing a graphical user interface enabling the first user to pursue a multi-level transaction with the second user and a third user owning an item associated with information matching information associated with an item the second user wants to receive.

2. The method of claim 1, wherein types of information associated with an item include one or more of a category, a location, and an approximate value, and wherein determining whether information associated with the item the first user wants to receive matches information associated with an item a second user owns includes determining whether one or more of a category, a location, and an approximate value match.

3. The method of claim 2, wherein determining whether information associated with the item the first user wants to receive matches information associated with an item a second user owns includes determining whether information matches based on one or more parameters provided by the first user.

4. The method of claim 1, wherein the graphical user interface enabling the first user to pursue a multi-level transaction includes a graphical user interface displaying items the second user owns and items the second user wants to receive.

5. The method of claim 4, wherein the graphical user interface enabling the first user to pursue a multi-level transaction further includes an icon that, upon activation, causes a list to be presented, wherein the list includes one or more third users owning an item associated with information matching information associated with an item the second user wants to receive.

6. The method of claim 5, wherein the list further includes an item a third user owns and an item a third user wants to receive for each of the respective one or more third users.

7. The method of claim 6, wherein the list further includes an icon enabling the first user to contact the second user and a third user in order to pursue a transaction.

8. The method of claim 7, further comprising presenting a graphical user interface displaying a trade status for each of a contacted second user and a contacted third user.

9. The method of claim 8, wherein a trade status includes one or more of not seen, active, and declined.

10. A non-transitory computer-readable storage medium having instructions stored thereon that upon execution cause one or more processors of a device to:
provide a graphical user interface enabling a first user to associate information with an item the first user owns;
provide a graphical user interface enabling the first user to associate information with an item the first user wants to receive;
determine whether information associated with the item the first user wants to receive matches information associated with an item a second user owns; and
provide a graphical user interface enabling the first user to pursue a multi-level transaction with the second user and a third user owning an item associated with information matching information associated with an item the second user wants to receive.

11. The non-transitory computer-readable storage medium of claim 10, wherein types of information associated with an item include one or more of a category, a location, and an approximate value, and wherein determining whether information associated with the item the first user wants to receive matches information associated with an item a second user owns includes determining whether one or more of a category, a location, and an approximate value match.

12. The non-transitory computer-readable storage medium of claim 11, wherein determining whether information associated with the item the user wants to receive matches information associated with an item a second user owns includes determining whether information matches based on one or more parameters provided by the first user.

13. The non-transitory computer-readable storage medium of claim 10, wherein the graphical user interface enabling the first user to pursue a multi-level transaction includes a graphical user interface displaying items the second user owns and items the second user wants to receive.

14. The non-transitory computer-readable storage medium of claim 13, wherein the graphical user interface enabling the first user to pursue a multi-level transaction further includes an icon that, upon activation, causes a list to be presented, wherein the list includes one or more third users owning an item associated with information matching information associated with an item the second user wants to receive.

15. The non-transitory computer-readable storage medium of claim 14, wherein the list further includes an item a third user owns and an item a third user wants to receive for each of the respective one or more third users.

16. The non-transitory computer-readable storage medium of claim 15, wherein the list further includes an icon enabling the first user to contact the second user and a third user in order to pursue a transaction.

17. The non-transitory computer-readable storage medium of claim 16, further comprising presenting a graphical user interface displaying a trade status for each of a contacted second user and a contacted third user.

18. The non-transitory computer-readable storage medium of claim 17, wherein a trade status includes one or more of not seen, active, and declined.

19. A device for facilitating item exchanges between three or more users, comprising one or more processors configured to:
provide a graphical user interface enabling a first user to associate category, location, and approximate value information with an item the first user owns;
provide a graphical user interface enabling the first user to associate category, location, and approximate value information with an item the first user wants to receive;
determine whether one or more of category, location, and approximate value information associated with the item the first user wants to receive matches category, location, and approximate value information associated with an item a second user owns; and
provide a graphical user interface enabling the first user to pursue a multi-level transaction with the second user and a third user owning an item associated with information matching information associated with an item the second user wants to receive, wherein the graphical user interface includes an icon that, upon activation, causes a list to be presented, wherein the list includes one or more third users owning an item associated with information matching information associated with an item the second user wants to receive, and wherein the list further includes an icon enabling the first user to contact the second user and a third user in order to pursue a transaction.

20. The device of claim 19, wherein determining whether one or more of category, location, and approximate value information associated with the item the first user wants to receive matches category, location, and approximate value information associated with an item a second user owns includes determining whether information matches based on one or more parameters provided by the first user.
